(19) United States
(12) Patent Application Publication
(10) Pub. No.: US 2026/0091590 A1
(43) Pub. Date: Apr. 2, 2026

(54) INK CARTRIDGE AND REMANUFACTURING METHOD OF THE SAME

(71) Applicant: CANON KABUSHIKI KAISHA, Tokyo (JP)

(72) Inventor: TAKAAKI SAITO, Kanagawa (JP)

(21) Appl. No.: 19/333,180

(22) Filed: Sep. 18, 2025

(30) Foreign Application Priority Data
Jul. 25, 2025 (JP) 2025-124791
Sep. 30, 2024 (JP) 2024-170039

(51) Int. Cl. B41J 2/175

(52) U.S. Cl. CPC B41J 2/17559; B41J 2/17506; B41J 2/17513; B41J 2/17553

(57) ABSTRACT

A method for remanufacturing an ink cartridge including an ink retention member configured to retain ink, a tank member that has an opening portion configured to serve as an opening and a storage portion configured to house the ink retention member, and a lid member joined to the opening portion and configured to cover the opening, the method including separating the lid member from the opening portion, removing the ink retention member from the storage portion through the opening, inserting the ink retention member different from the ink retention member removed in the removing into the storage portion through the opening, and joining the lid member different from the lid member separated in the separating to the opening portion, wherein the method includes heat shrink processing for heating and shrinking the ink retention member to be removed in the removing prior to the removing.

### BACKGROUND

### Field of the Technology

The present disclosure relates to an ink cartridge and a method for remanufacturing the same.

### Description of the Related Art

A liquid ejection apparatus is provided with a liquid ejection head for ejecting liquid, whereby various purposes are achieved by liquid ejection. For example, in an ink jet recording apparatus, an ink jet recording head for ejecting liquid is mounted on a carriage and ejects ink to a recording medium to record an image, a character, and like. Liquid to be ejected from the liquid ejection apparatus is supplied to the liquid ejection head from a cartridge configured to be detachably attached to the liquid ejection apparatus.

Japanese Patent No. 3281329 describes an ink cartridge that is provided with an ink retention member retaining ink, a tank member having an opening portion serving as an opening for inserting the ink retention member and a storage portion for storing the ink retention member, and a lid member that is joined to the opening portion to cover the opening.

The ink retention member is formed by using polypropylene as a core material and high-density polyethylene having a lower melting point than the core material as an outer periphery portion and by welding intersections where fibers overlap with each other by heat. The ink retention member is housed in the storage portion without gaps and functions as the ink retention member by allowing ink to penetrate into voids formed in the fibers.

In recent years, in order to realize a decarbonized and sound material-cycle society, there is a demand for an ink cartridge to also be environmentally friendly. Thus, attempts have been considered for manufacturers and the like to collect ink cartridges that have run out of ink and can no longer be used from users, and to reuse or recycle them. One example of the attempts is a method in which collected ink cartridges are disassembled and cleaned so that some of their components are reused as they are and some are replaced with new ones, making it possible to reuse or recycle them. However, in a case of the ink cartridge described in Japanese Patent No. 3281329, the ink cartridge has a structure in which fibers are heat welded to the ink retention member, and thus, it is considered that the ink retention member will be replaced with a new one because it is difficult to clean the ink retained inside. In order to do so, it is necessary to separate the lid member joined to the opening portion and remove the ink retention member from the tank member.

In the ink cartridge described in Japanese Patent No. 3281329, a burr may be generated at the opening portion if the lid member is separated from the opening portion, and since the ink retention member is housed in the storage portion without gaps, there is a risk that the ink retention member may get caught on the burr in being removed.

In other words, there is a concern that a takt time used for reusing (remanufacturing) ink cartridges will increase, which hinders the promotion of ink cartridge remanufacturing.

### SUMMARY

The present disclosure is directed to the provision of a method for easily remanufacturing an ink cartridge and an ink cartridge that can be easily remanufactured in view of the above-described issues.

According to some embodiments of the present disclosure, a method for remanufacturing an ink cartridge including an ink retention member configured to retain ink, a tank member that has an opening portion configured to serve as an opening and a storage portion configured to house the ink retention member, and a lid member joined to the opening portion and configured to cover the opening, the method including separating the lid member from the opening portion, removing the ink retention member from the storage portion through the opening, inserting the ink retention member different from the ink retention member removed in the removing into the storage portion through the opening, and joining the lid member different from the lid member separated in the separating to the opening portion, wherein the method includes heat shrink processing for heating and shrinking the ink retention member to be removed in the removing prior to the removing.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a liquid ejection apparatus.

FIG. 2 is a perspective view illustrating an ink cartridge.

FIG. 3 is an exploded view illustrating the ink cartridge.

FIG. 4A is a cross-sectional view illustrating the ink cartridge in which a sufficient amount of ink remains, and FIG. 4B is a cross-sectional view of the ink cartridge that has run out of ink.

FIG. 5A is a perspective view illustrating an ink retention member, FIG. 5B is an enlarged cross-sectional view of a fiber, and FIG. 5C is a schematic diagram illustrating a grating structure of fibers.

FIG. 6 is a flowchart illustrating manufacturing of the ink cartridge.

FIG. 7 is a schematic diagram illustrating processing for heating and shrinking the ink retention member.

FIG. 8 is a schematic diagram illustrating processing for heating and shrinking the ink retention member.

FIG. 9 is a schematic diagram illustrating processing for heating and shrinking the ink retention member.

FIG. 10 is a perspective view illustrating processing for removing the ink retention member from a storage portion.

FIG. 11 is a perspective view illustrating the ink retention member.

FIG. 12A is a top view illustrating the ink retention member before being subjected to the processing for heating and shrinking, and FIG. 12B is a top view illustrating the ink retention member after being subjected to the processing for heating and shrinking.

FIG. 13 is a perspective view illustrating processing for removing the ink retention member from the storage portion.

FIG. 14 is a top view illustrating the ink retention member in a processing for heating and shrinking the ink retention member.

FIG. 15 is a perspective view of the ink retention member.

### DESCRIPTION OF THE EMBODIMENTS

Hereinafter, various exemplary embodiments, features, and aspects of the present disclosure will be described with reference to the drawings. The following embodiments are not intended to limit the scope of the present disclosure, and not all combinations of features described in the embodiments are necessarily essential to the solutions of the present disclosure. Furthermore, identical components are denoted by the same reference numerals.

### First Embodiment

### Ink Jet Recording Apparatus

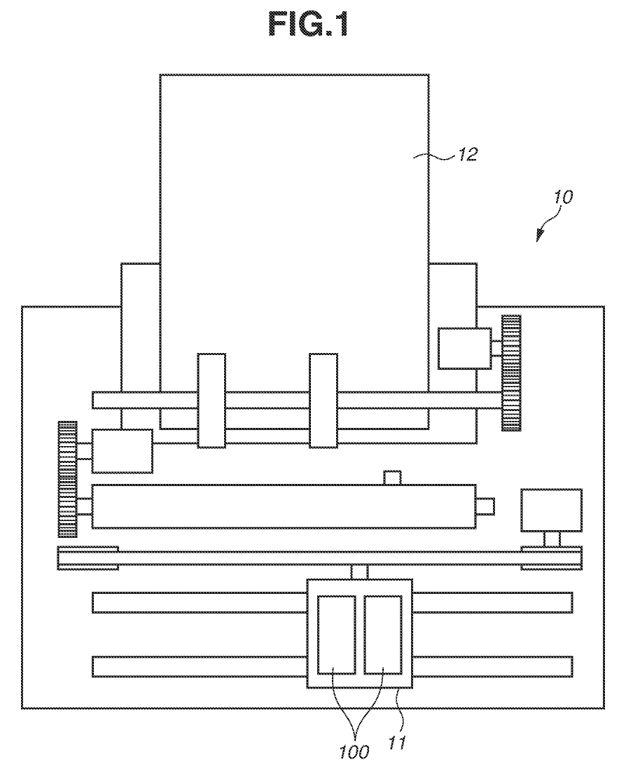

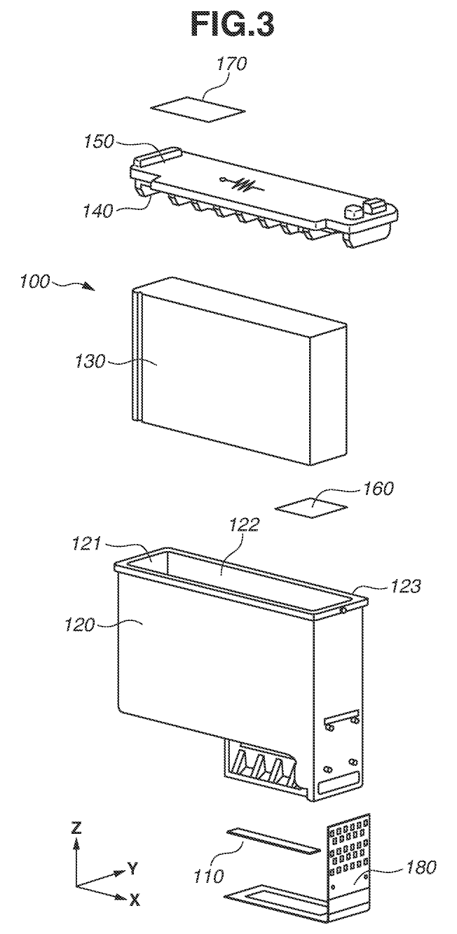

FIG. 1 is a schematic diagram illustrating a liquid ejection apparatus according to a first embodiment. While the liquid ejection apparatus according to the present embodiment is an ink jet recording apparatus, the present disclosure is not limited to the liquid ejection apparatus as long as it is an apparatus configured to eject liquid. An ink jet recording apparatus 10 (hereinbelow, also referred to as the recording apparatus) is an on-carriage type apparatus adopting a serial recording method and includes ink cartridges 100 (hereinbelow, also referred to as cartridge) and a carriage 11. The cartridges 100 according to the present embodiment each includes an ejection element substrate 110 (FIG. 3) and are mounted on the carriage 11. The recording apparatus 10 according to the present embodiment is a serial scanning type in which the carriage 11 reciprocates, a recording medium 12 is conveyed in a direction perpendicular to the reciprocating movement of the carriage 11, and the cartridges 100 eject ink onto the recording medium 12 to form an image on the recording medium 12.

### Ink Cartridge

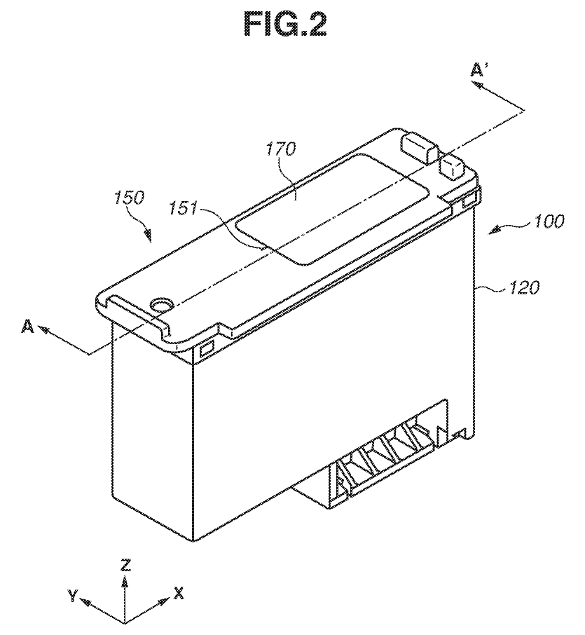

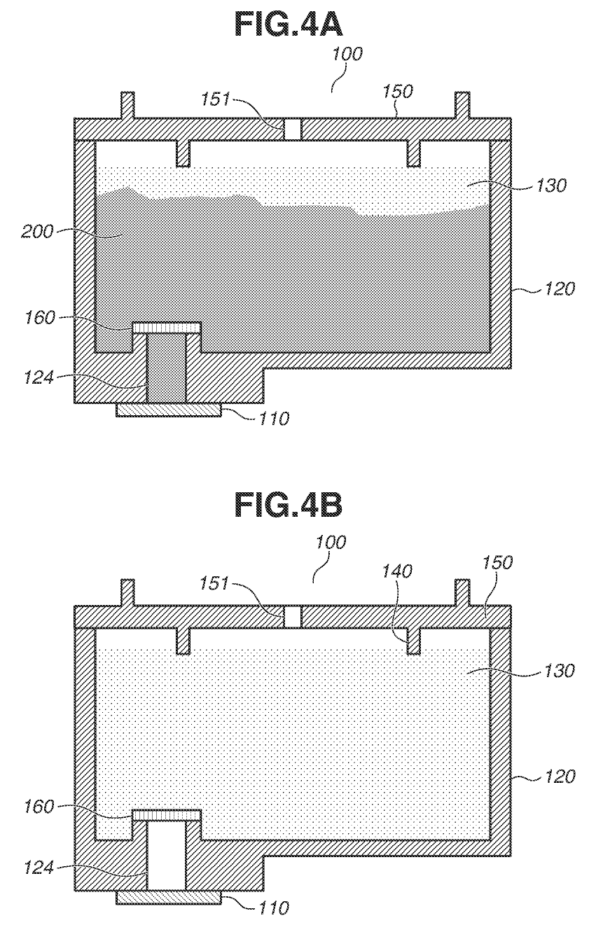

FIG. 2 is a perspective view of a cartridge 100. FIG. 3 is an exploded perspective view of the cartridge 100. FIGS. 4A and 4B are cross-sectional views of the cartridge 100 taken along a line A-A' in FIG. 2. FIG. 4A illustrates the cartridge 100 in which a sufficient amount of ink 200 remains, and FIG. 4B illustrates the cartridge 100 that has run out of ink. The cartridge 100 that has run out of ink as in the state illustrated in FIG. 4B is collected by a manufacturer or the like and remanufactured (reused). Remanufacturing of the cartridge is described below.

The cartridge 100 according to the present embodiment is a type that contains ink of one color inside and is generally a cartridge for black ink. The present disclosure can also be applied to a type that contains ink of a plurality of colors, generally a cartridge for color ink (cyan, magenta, and yellow), but the present embodiment is described using a cartridge for black ink.

In the cartridge for color ink, ink retention members 130 are housed in a storage portion in the same number as the types of ink. In a remanufacturing method according to the present embodiment, a plurality of the ink retention members 130 can be easily removed from the storage portion by a single heat shrink processing, so that the remanufacturing method according to the present embodiment is suitable for the cartridge for color ink.

As illustrated in FIG. 3, the cartridge 100 is provided with the ink retention member 130 that retains the ink and a tank member that has an opening portion 123 serving as an opening 122 through which the ink retention member 130 is inserted, and a storage portion 121 that houses the ink retention member 130. The ink retention member 130 is described in detail below.

The cartridge 100 includes a lid member 150 that is joined to the opening portion 123 and covers the opening 122. There is no particular limitation on joining between the opening portion 123 and the lid member 150, but it is desirable that the opening portion 123 and the lid member 150 are welded together in order to reduce a risk of ink leaking from the cartridge 100. Further, the lid member 150 includes a rib 140 that comes into contact with the ink retention member 130. The rib 140 is a member for fixing the ink retention member 130 to the inside of the storage portion 121. While, in FIG. 3, the lid member 150 and the rib 140 are integrally formed, the lid member 150 and the rib 140 may be separate bodies.

The ejection element substrate 110 that includes an ejection port array (not illustrated) for ejecting liquid is provided on a bottom surface of the tank member below in a vertical direction. The ejection element substrate 110 includes an ejection element (not illustrated) that generates energy for ejecting liquid from the ejection port array. The ejection element may be a thermal type that generates pressure for liquid ejection using a thermoelectric conversion element or a piezoelectric type that generates pressure for liquid ejection using a piezoelectric element. The ejection element may be any other type of liquid ejection method. While, according to the present embodiment, the cartridge 100 includes the ejection element substrate 110, it may be configured without an ejection element substrate and to supply liquid from the cartridge 100 to an ink ejection head that includes an ejection element substrate. The cartridge 100 includes an electric wiring member 180 that supplies electric power from the outside to the ejection element.

The storage portion 121 is provided with an ink supply portion 124 (FIGS. 4A and 4B) for supplying ink from the ink retention member 130 to the ejection element substrate 110. It is desirable that the storage portion 121 should be provided with a filter 160 for removing a foreign substance that can be supplied together with the ink to the ink supply portion 124. The ink retention member 130 is in pressure contact with the ink supply portion 124 via the filter 160 inside the storage portion 121.

When the liquid is supplied from the storage portion 121 to the ink supply portion 124, the storage portion 121 needs to take in air. Thus, the lid member 150 has an air communication hole 151 formed therein for taking air into the storage portion 121 even when the lid member 150 is joined to a tank member 120. In order to reduce a risk of ink inside the storage portion 121 leaking from the air communication hole 151, a sealing member 170 that covers a part of the air communication hole 151 is provided on the lid member 150.

### Ink Retention Member

The ink retention member 130 is described in detail. The ink retention member 130 is a member that retains ink by capillary force. The capillary force is determined by wettability of the ink retention member 130 with respect to the ink and size and proportion of voids present inside the ink retention member 130. Examples of materials for the ink retention member 130 include a polypropylene (PP) fiber, a low-density polyethylene (PE) fiber, a high-density polyethylene (PE) fiber, urethane foam, a polyester felt fiber, and the like, and the ink retention member 130 may be made of a single material or a plurality of materials.

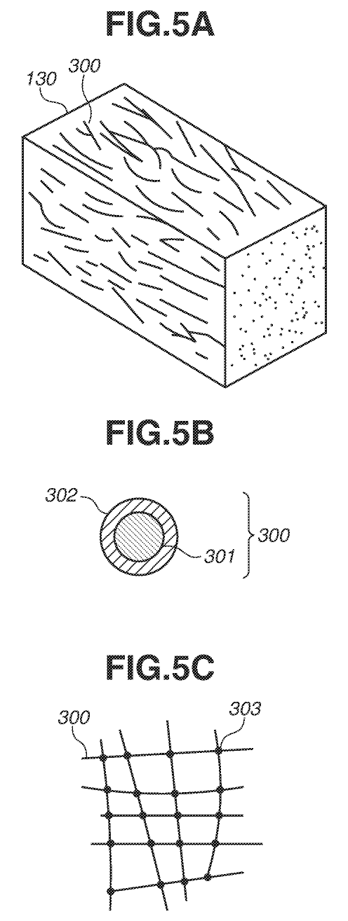

FIGS. 5A to 5C are schematic drawings illustrating the ink retention member 130 according to the present embodiment. FIG. 5A is a perspective view of the ink retention member 130. The ink retention member 130 is an aggregate of a large number of fibers 300. While a shape of the ink retention member 130 is not particularly limited, it is desirable that the shape should be the same as that of the storage portion 121. According to the present embodiment, the storage portion 121 has a rectangular parallelepiped shape, and the ink retention member 130 also has a rectangular parallelepiped shape.

FIG. 5B is an enlarged cross-sectional view of a structure of the fiber 300 of the ink retention member 130. The fiber 300 of the ink retention member 130 according to the present embodiment is made of two types of materials. As the two types of materials used for an outer periphery portion and a center portion, a material having a lower melting point (softening point) than a material for a center portion 301 can be adopted as a material for an outer periphery portion 302. For example, low-density polyethylene or high-density polyethylene can be adopted as a material for the outer periphery portion 302, and polypropylene can be adopted as a material for the center portion 301.

FIG. 5C is a schematic diagram illustrating a grating structure of the fibers 300. Since the melting point (softening point) of the outer periphery portion 302 is lower than the melting point (softening point) of the center portion 301, when the fiber 300 is heated at a temperature at which only the material of the outer periphery portion 302 melts (softens), only the outer periphery portion 302 melt (soften) at intersections 303 where the fibers 300 intersect each other and bond the fibers 300 to each other. In this way, the fibers 300 bond together and form the ink retention member 130.

### Cartridge Remanufacturing

A processing for remanufacturing (reusing) the cartridge 100 is described. Remanufacturing of the cartridge 100 according to the present embodiment refers to regenerating the cartridge 100 by reusing the tank member 120 and removing the used ink retention member 130 after heating and shrinking the used ink retention member 130. In other words, remanufacturing refers to manufacturing an intermediate for manufacturing the cartridge 100. The processing is described in detail below.

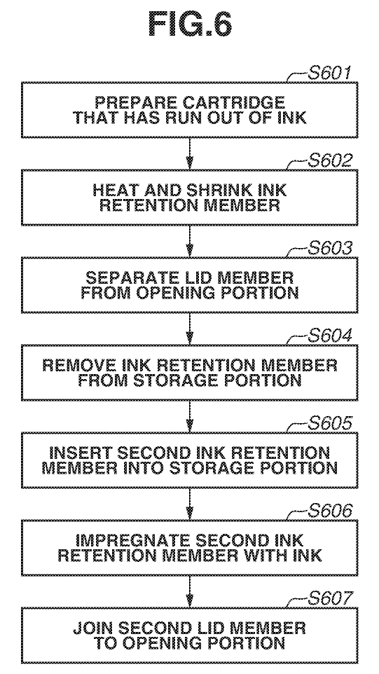

FIG. 6 is a flowchart illustrating a remanufacturing processing procedure of the cartridge 100. In step S601, the cartridge 100 that has run out of ink is prepared. For example, the cartridge 100 has been distributed in the market, and then the used cartridge 100 has been collected and prepared.

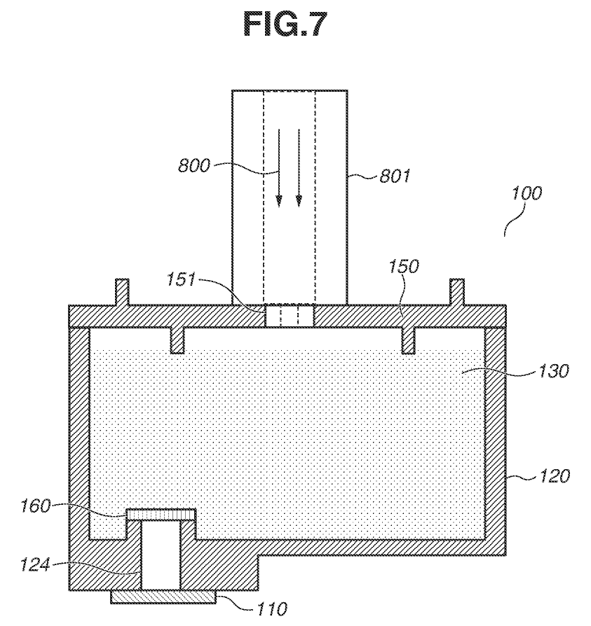

In step S602, the ink retention member 130 is heated and shrunk. As will be described below, this processing is intended to facilitate processing in step S604 even if a burr is generated at the opening portion 123 in step S603. Thus, the processing for heating and shrinking the ink retention member 130 is performed prior to processing for removing the ink retention member 130 from the storage portion 121. In step S602 according to the present embodiment, as illustrated in FIG. 7, the air communication hole 151 is expanded, and an air blow 800 is blown from an air blow nozzle 801 into the air communication hole 151 to heat the inside of the cartridge 100.

A heating temperature at this processing is a temperature at which the material of the ink retention member 130 starts to heat shrink or higher. When the ink retention member 130 is heated to the heat shrinkage heating temperature or higher, heat shrinkage occurs in the material of the ink retention member 130. Consequently, a volume of the ink retention member 130, which is tightly housed in the storage portion 121, is reduced, which facilitates the processing in step S604. Step S604 is described below.

Heating the inside of the cartridge 100 in step S602 can also improve cleaning and drying effects in removing an ink smudge or the like from inside the cartridge 100. The heating temperature in this processing is desirably a temperature that does not damage the reused members of the cartridge 100 and is desirably 100°C or lower.

The heating temperature in step S602 is desirably a temperature at which the material of the ink retention member 130 starts to heat shrink or higher and the softening point of the material or higher. When the ink retention member 130 is heated to the softening point of the material thereof, the ink retention member 130 shrinks more, facilitating the processing in step S604, which is described below.

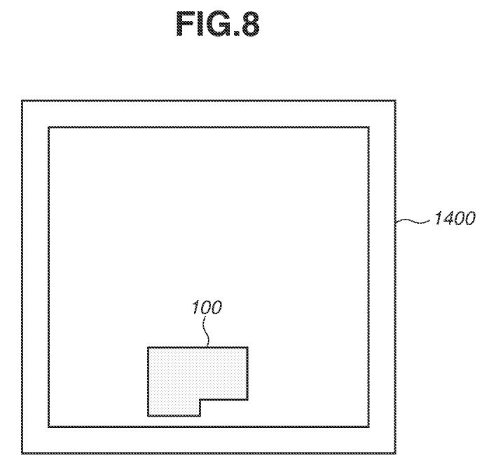

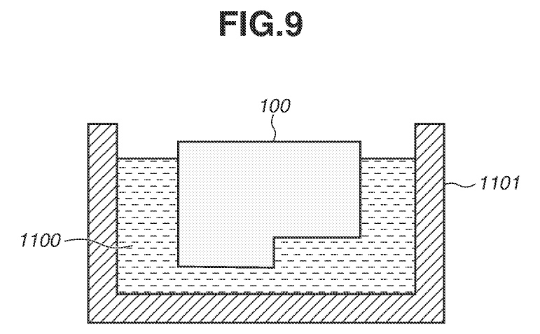

In step S602, instead of blowing the air blow 800 from the air blow nozzle 801, the ink cartridge 100 may be placed and heated in a batch furnace 1400 as illustrated in FIG. 8. Further, as illustrated in FIG. 9, the ink retention member 130 may be heated by immersing the cartridge 100 for a while in a heating tub 1101 filled with hot water 1100 at about 100 °C.

In step S603, the lid member 150 is separated from the opening portion 123. In a case where the lid member 150 is welded to the opening portion 123, the lid member 150 can be separated from the opening portion 123 by peeling or cutting. When the lid member 150 is separated from the opening portion 123, a burr can be generated at the opening portion 123. This processing may be performed prior to step S602. Even in that case, step S602 needs to be performed prior to step S604.

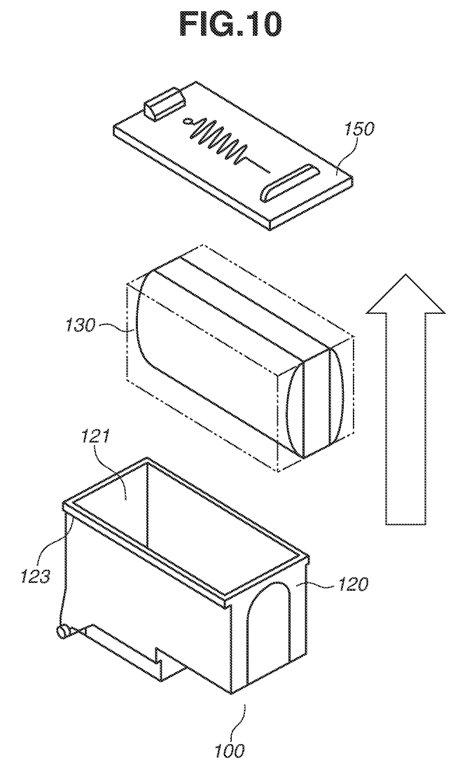

In step S604, the ink retention member 130 is removed from the storage portion 121. According to the conventional technique, since step S602 is not performed, there is a risk that the ink retention member 130 may get caught on a burr at the opening portion 123 in removing the ink retention member 130 that is housed in the storage portion 121 without gaps. On the other hand, according to the present embodiment, since step S602 is performed, the volume of the ink retention member 130 is reduced with respect to the storage portion 121. In this state, even in a case where step S604 is performed, the ink retention member 130 has become smaller, the risk of the burr at the opening portion 123 interfering with the ink retention member 130 is reduced, and as illustrated in FIG. 10, the ink retention member 130 can be easily removed from the storage portion 121. Further, the heat-shrunk ink retention member 130 shrinks and hardens, so that the ink retention member 130 can be easily picked up and removed. Furthermore, since the volume of the removed ink retention member 130 is reduced due to heat shrinkage, the volume of members to be discarded is reduced, which may also reduce an environmental burden. In other words, the present manufacturing method can shorten a takt time required for reusing (remanufacturing) an ink cartridge and reduce the environmental burden, whereby remanufacturing of the ink cartridge can be promoted. In other words, the technique described in the present specification can contribute to realization of a sustainable society, such as a decarbonized and sound material-cycle society.

As described above, the ink cartridge 100 can be remanufactured (reused). An intermediate for manufacturing the ink cartridge 100 is manufactured. According to the present embodiment, in order to remanufacture the ink cartridge 100, the following processing is additionally performed on the intermediate.

In step S605, a second ink retention member (not illustrated) is inserted into the storage portion 121. In order to refill the ink cartridge 100 with ink, the second ink retention member, which is different from the ink retention member 130, is inserted into the cartridge 100. The ink retention member 130 may be cleaned and then inserted again into the ink cartridge 100. As a configuration of the second ink retention member, a configuration that can be used as the ink retention member 130 can be adopted. Prior to step S605, processing for cleaning and drying the inside of the storage portion 121 may be provided.

In step S606, the second ink retention member is impregnated with ink. In other words, step S606 is processing for filling the storage portion 121 with ink. The second ink retention member has the similar properties as the ink retention member 130 and thus can retain ink by absorbing the ink into voids in the fibers 300. In this processing, in a case where the ink retention member 130 is reused, the ink retention member 130 is impregnated with ink.

Finally, in step S607, a second lid member is joined to the opening portion 123. While a joining method is not particularly limited, it is desirable that the method should be the same as the method used to join the lid member 150 to the opening portion 123, and for example, joining by welding can be adopted. Instead of joining the second lid member, the lid member 150 may be reused and joined again to the opening portion 123.

As described above, according to the present disclosure, it is possible to provide a method for easily manufacturing an ink cartridge and an ink cartridge that can be easily remanufactured.

### Second Embodiment

A configuration of a cartridge 100 according to a second embodiment of the present disclosure is described. Particularly, the present embodiment is different from the first embodiment in an ink retention member. In the following description, only parts that are different from the first embodiment are mainly described, and the redundant descriptions of parts that are similar to the first embodiment is omitted.

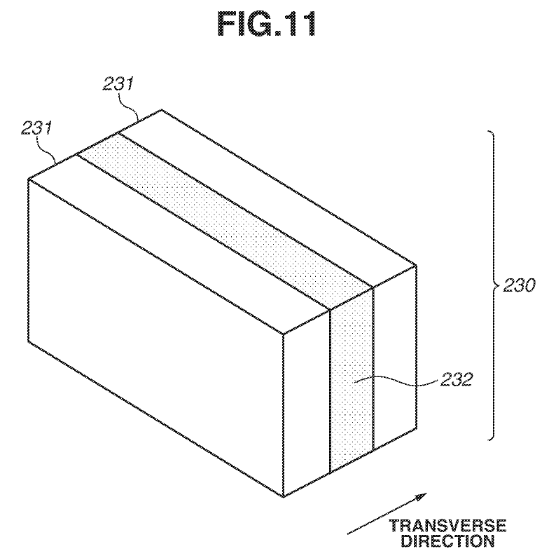

FIG. 11 is a perspective view of an ink retention member 230 according to the second embodiment. The ink retention member 230 according to the second embodiment includes first absorbers 231 and a second absorber 232 that is different from the first absorbers 231, and the first absorbers 231 have a higher softening point than the second absorber 232. As the first absorbers 231, high-density polyethylene, which generally has a softening point of about 90 °C to 110 °C can be adopted. As the second absorber 232, low-density polyethylene, which generally has a softening point of about 70 °C to 90 °C can be adopted. Further, the first absorbers 231 and the second absorber 232 are arranged in parallel in a transverse direction (predetermined direction) of the opening 122 of the cartridge 100, and the second absorber 232 is held between the first absorbers 231.

The ink retention member 230 can be manufactured in such a manner that the second absorber 232 is arranged to be held between the first absorbers 231, which are heated and pressed, and the first absorbers 231 and the second absorber 232 are heated and compressed in a direction, in which the first absorbers 231 and the second absorber 23 overlap, at a temperature at which the second absorber 232 is softened and welded.

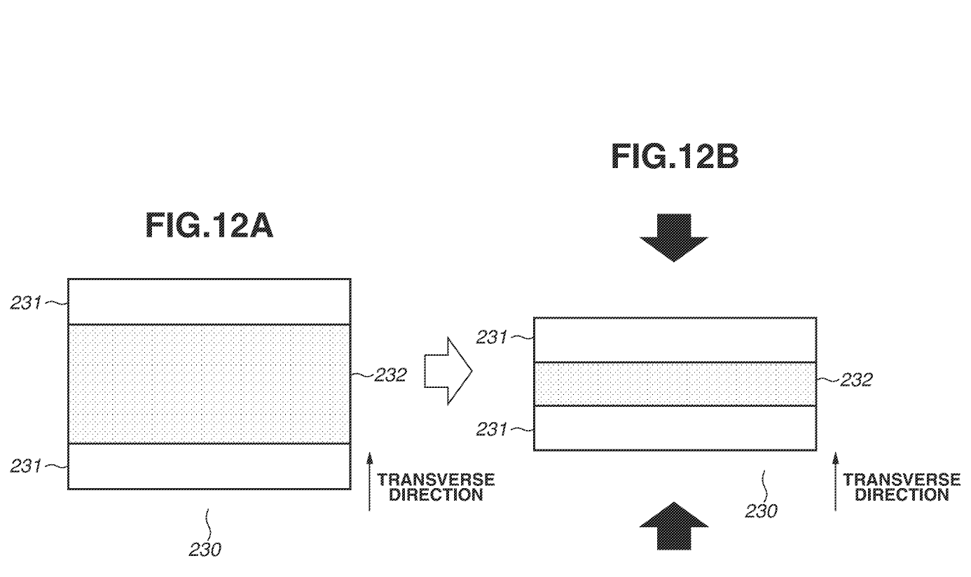

FIGS. 12A and 12B are top views illustrating the ink retention member 230 according to the second embodiment before and after being subjected to processing for heating and shrinking. FIG. 12A is the top view of the ink retention member 230 before being subjected to the processing for heating and shrinking, and FIG. 12B is the top view of the ink retention member 230 after being subjected to the processing for heating and shrinking. In the processing for heating and shrinking the ink retention member 230, the ink retention member 230 is heated at a temperature of the softening point of the second absorber 232 or higher and lower than the softening point of the first absorbers 231. Consequently, only the second absorber 232 is softened. Since the second absorber 232 is held between the first absorbers 231, the volume of the ink retention member 230 is reduced as the second absorber 232 softens.

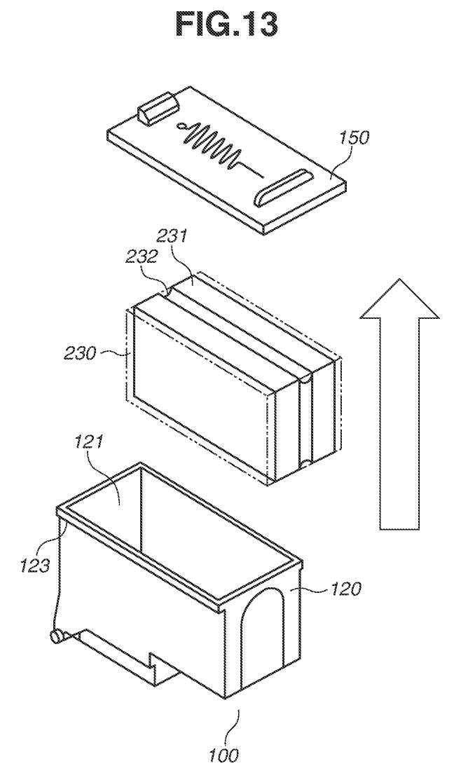

FIG. 13 is a diagram illustrating processing for removing the ink retention member 230 from the storage portion 121. As illustrated in FIG. 13, since the volume of the ink retention member 230 is reduced by being heated and shrunk, interference between the burr generated at the opening portion 123 and the ink retention member 230 can be suppressed in the processing for removing the ink retention member 230. In this processing, the first absorbers 231 holding the second absorber 232 do not soften, so that the first absorbers 231 can be easily grasped, and operability in the processing for removing the ink retention member 230 is not reduced. Therefore, with the manufacturing method according to the present embodiment, it is possible to more easily reuse (remanufacture) the ink cartridge.

According to the second embodiment, the second absorber 232 is arranged directly above the ink supply portion 124. By setting a void ratio of the second absorber 232 higher than a void ratio of the first absorbers 231, ink is more likely to gather around the ink supply portion 124, which improves efficiency of ink usage.

It is desirable that, as illustrated in FIG. 5B, the first absorbers 231 should have a configuration in which high-density polyethylene (second resin) covers polypropylene (first resin). It is desirable that, as illustrated in FIG. 5B, the second absorber 232 should have a configuration in which low-density polyethylene (fourth resin) covers polypropylene (third resin). Further, the processing for heating and shrinking the ink retention member 230 is desirably performed at a temperature of a softening point of the fourth resin or higher and lower than softening points of the first resin, the second resin, and the third resin.

### Third Embodiment

A configuration of a cartridge 100 according to a third embodiment of the present disclosure is described. Particularly, the present embodiment is different from the second embodiment in an ink retention member. Redundant descriptions of details similar to those of the first and second embodiments is omitted.

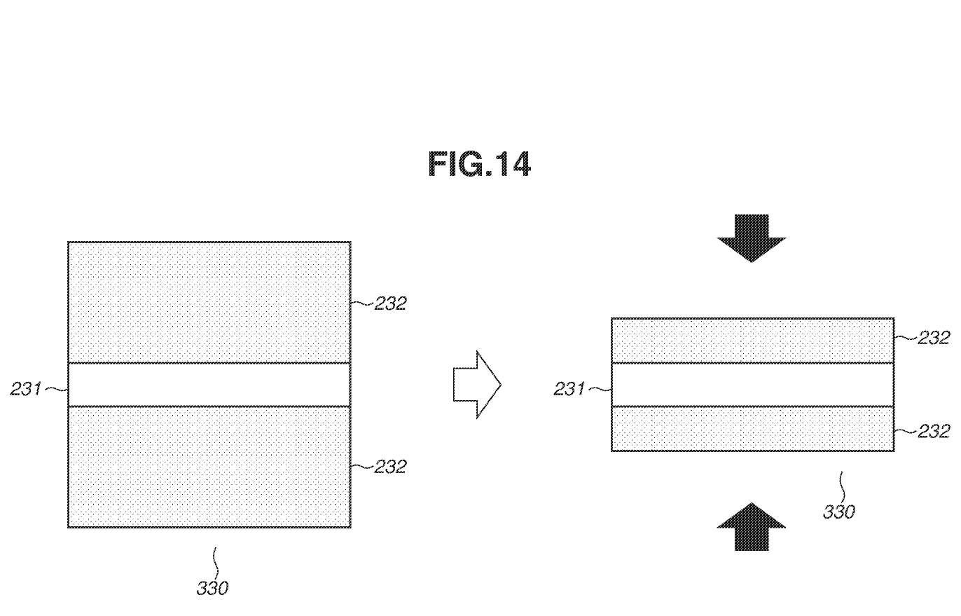

FIG. 14 is a diagram illustrating an ink retention member 330 according to the present embodiment. The ink retention member 330 has a configuration in which a first absorber 231 is held between second absorbers 232. The ink retention member 330 can be manufactured in such a manner that the second absorbers 232 are arranged to hold the first absorber 231, which is heated and pressed, therebetween, and the first absorber 231 and the second absorbers 232 are heated and compressed in a direction in which the first absorber 231 and the second absorbers 232 overlap at a temperature at which the second absorbers 232 are softened and welded. According to the present embodiment, the ink cartridge 100 that houses the ink retention member 330 is prepared.

Then, in a processing for remanufacturing the cartridge 100, the ink retention member 330 is heated to shrink at a temperature of the softening point of the second absorber 232 or higher and lower than the softening point of the first absorber 231. Consequently, only the second absorbers 232 holding the first absorber 231 cause heat shrinkage, and the volume of the ink retention member 330 is reduced. Thus, in a processing for removing the ink retention member 330 from the storage portion 121, a risk of the ink retention member 330 interfering with the burr generated at the opening portion 123 is reduced. Further, since a proportion of the second absorbers 232 in the ink retention member 330 is large compared with the second embodiment, a volume reduction rate of the ink retention member 330 can be increased. Thus, interference between the ink retention member 330 and the burr generated at the opening portion 123 can be further reduced.

Since the first absorber 231 held between the second absorbers 232 does not soften, the first absorber 231 can be easily grasped, and operability in the processing for removing the ink retention member 330 is not reduced. Therefore, according to the method for remanufacturing the cartridge 100 according to the present embodiment, (remanufacture) the ink cartridge can be more easily reused.

According to the third embodiment, the first absorber 231 is disposed directly above the ink supply portion 124. By setting a void ratio of the first absorber 231 higher than that of the second absorber 232, ink is more likely to gather around the ink supply portion 124, which improves efficiency of ink usage.

### Modification

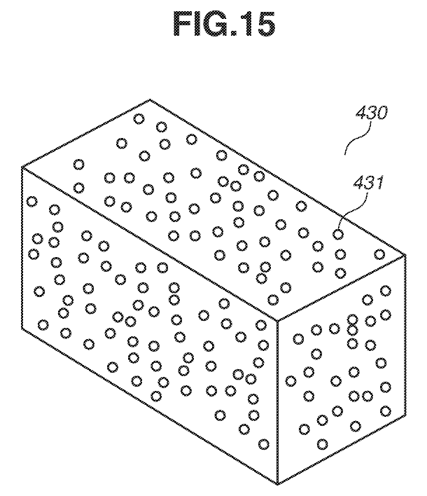

A modification of an ink retention member is described. FIG. 15 illustrates a modification of an ink retention member 430. According to the first embodiment, the ink retention member is formed of fibers made of a plurality of materials as illustrated in FIGS. 5A to 5C, but the ink retention member 430 according to the modification is made of a single material. As a material that can form the ink retention member 430 as a single material, polyurethane foam containing bubbles 431 therein can be adopted.

As described above, the present disclosure can shorten a takt time required for reusing (remanufacturing) an ink cartridge and reduce the environmental burden, whereby remanufacturing of the ink cartridge can be promoted. In other words, the technique described in the present specification can contribute to realization of a sustainable society, such as a decarbonized and sound material-cycle society.

According to the present disclosure, it is possible to provide a method for easily manufacturing an ink cartridge and an ink cartridge that can be easily remanufactured.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-170039, filed September 30, 2024, and Japanese Patent Application No. 2025-124791, filed July 25, 2025, which are hereby incorporated by reference herein in their entirety.

What is claimed is:

1. A method for remanufacturing an ink cartridge including an ink retention member configured to retain ink, a tank member that has an opening portion configured to serve as an opening and a storage portion configured to house the ink retention member, and a lid member joined to the opening portion and configured to cover the opening, the method comprising:
separating the lid member from the opening portion;
removing the ink retention member from the storage portion through the opening;
inserting the ink retention member different from the ink retention member removed in the removing into the storage portion through the opening; and
joining the lid member different from the lid member separated in the separating to the opening portion,
wherein the method includes heat shrink processing for heating and shrinking the ink retention member to be removed in the removing prior to the removing.

2. The method for remanufacturing the ink cartridge according to claim 1, further comprising filling the storage portion with ink prior to the joining.

3. The method for remanufacturing the ink cartridge according to claim 1, wherein the heat shrink processing is performed at a temperature of a softening point of a material included in the ink retention member to be removed in the removing or higher.

4. The method for remanufacturing the ink cartridge according to claim 1,
wherein the ink retention member to be removed in the removing includes a first absorber and a second absorber different from the first absorber,
wherein a softening point of the first absorber is higher than a softening point of the second absorber, and
wherein the heat shrink processing is performed at a temperature of the softening point of the second absorber or higher and lower than the softening point of the first absorber.

5. The method for remanufacturing the ink cartridge according to claim 4, wherein the first absorber and the second absorber are arranged in parallel in a transverse direction of the opening.

6. The method for remanufacturing the ink cartridge according to claim 5, wherein the second absorber is held between the first absorbers in the transverse direction of the opening.

7. The method for remanufacturing the ink cartridge according to claim 5, wherein the first absorber is held between the second absorbers in the transverse direction of the opening.

8. The method for remanufacturing the ink cartridge according to claim 4, wherein the first absorber contains high-density polyethylene, and the second absorber contains low-density polyethylene.

9. The method for remanufacturing the ink cartridge according to claim 8,
wherein the first absorber contains polypropylene covered with the high-density polyethylene, and
wherein the second absorber contains polypropylene covered with the low-density polyethylene.

10. The method for remanufacturing the ink cartridge according to claim 9, wherein the first absorber and the second absorber are compressed in a transverse direction of the opening to serve as the ink retention member.

11. The method for remanufacturing the ink cartridge according to claim 1,
wherein the ink retention member to be removed in the removing includes a first absorber and a second absorber different from the first absorber,
wherein the first absorber includes a first resin and a second resin covering the first resin,
wherein the second absorber includes a third resin and a fourth resin covering the third resin, and
wherein the processing for heating and shrinking the ink retention member is performed at a temperature of a softening point of the fourth resin or higher and lower than softening points of the first resin, the second resin, and the third resin.

12. The method for remanufacturing the ink cartridge according to claim 1, wherein the lid member to be separated in the separating is welded to the opening portion.

13. The method for remanufacturing the ink cartridge according to claim 1, wherein the separating separates the lid member from the opening portion by peeling.

14. The method for remanufacturing the ink cartridge according to claim 1, wherein the tank member is provided with an ejection element substrate including an ejection port array configured to eject ink.

15. The method for remanufacturing the ink cartridge according to claim 14,
wherein the storage portion is provided with an ink supply portion configured to supply ink from the ink retention member to the ejection element substrate, and
wherein the ink retention member is pressure contact with the ink supply portion.

16. An ink cartridge comprising:
an ink retention member configured to retain ink;
a tank member that has an opening portion serving as an opening and a storage portion configured to house the ink retention member; and
a lid member joined to the opening portion and configured to cover the opening,
wherein the ink retention member includes a first absorber and a second absorber different from the first absorber,
wherein a softening point of the first absorber is higher than a softening point of the second absorber, and
wherein the first absorber and the second absorber are compressed in a predetermined direction and arranged in parallel in the predetermined direction.

17. The ink cartridge according to claim 16, wherein the first absorber is held between the second absorbers in the predetermined direction.

18. The ink cartridge according to claim 16, wherein the second absorber is held between the first absorbers in the predetermined direction.

19. The ink cartridge according to claim 16, wherein the predetermined direction is a transverse direction of the opening.

20. A method for manufacturing an intermediate that is used to manufacture an ink cartridge provided with an ink retention member configured to retain ink, a tank member that has an opening portion configured to serve as an opening and a storage portion configured to store the ink retention member, and a lid member joined to the opening portion and configured to cover the opening,
wherein the intermediate includes the tank member,
wherein the method includes separating the lid member from the opening portion, and
removing the ink retention member from the storage portion through the opening, and
wherein the method includes heat shrinking for heating and shrinking the ink retention member to be removed in the removing prior to the removing.
